(19) United States
(12) Patent Application Publication
(10) Pub. No.: US 2017/0005495 A1
(43) Pub. Date: Jan. 5, 2017

(54) METHOD AND APPARATUS FOR CHARGING ELECTRONIC DEVICE WITH USB CONNECTION

(71) Applicant: THOMSON LICENSING, Issy-Les-Moulineaux (FR)

(72) Inventors: Yuanhuai YANG, Beijing (CN); Dongsheng QU, Beijing (CN); Longbo CAO, Beijing (CN)

(21) Appl. No.: 15/105,290

(22) PCT Filed: Dec. 19, 2013
(86) PCT No.: PCT/CN2013/090000

§ 371 Date: Jun. 16, 2016

(51) Int. Cl. H02J 7/00; G06F 13/42; G06F 1/26; G06F 13/40

(52) U.S. Cl. CPC H02J 7/0052; G06F 13/4068; G06F 13/4282; G06F 1/263; H02J 2007/0062; H02J 2007/006; G06F 2213/0042

(57) ABSTRACT

A method and an apparatus for charging an electronic device with USB connection are provided. The method comprises, at the side of the first electronic device which is charged by a second electronic device, the steps of: receiving a power supply at a first voltage level from the second electronic device (201); detecting whether there is data communication on the USB connection (202), if there is no data communication on the USB connection, transmitting a message to the second electronic device to request for being charged at a second voltage level which is greater than the first voltage level (203); and receiving a power supply at the second voltage level from the second electronic device.

### TECHNICAL FIELD

The present invention generally relates to electronic products. In particular, the present invention relates to a method and an apparatus for charging an electronic device with USB connection.

### BACKGROUND

Currently almost all electronic products, such as mobile phones, PDAs (Personal Digital Assistants) and tablet computers, are provided with one or more Universal Serial Bus (USB) ports. USB is an industry standard that defines the cables, connectors and communication protocols used in a bus for connection, communication and power supply between computers and electronic devices. USB was designed to standardize the connection of electronic devices, both to communicate and to supply electric power.

The USB standard describes a USB battery charging specification, with which the battery of an electronic device can be charged from a power supply connected to the electronic device with a USB port. The power supply can be from a battery of another electronic device, or from an AC power source, in which case an adapter is needed. Normally a micro B connector defined in the USB standard is used to charge the battery of a connected electronic device. According to the specification, a USB charging port supplies up to 500 mA at a DC power supply of 5V. That is, when an electronic device is working as a host, it will output 5.0V power supply with the USB charging port to an external electronic device. Similarly, when an electronic device is working as a client, it can use a 5.0V power supply from an external power supply to charge its battery or to be directly provided with the power consumption from the external power supply.

At present, the power level of electronic devices increases a lot. The reason may comprise the usage of bigger LCD and running of big applications, e.g. complex software on the electronic devices, which will all result in a high power consumption of the electronic devices. However, since the micro B connector is very compact, its connection pin could not bear big current. So far the biggest current with such charging solution can only be up to 2 A, which will be very difficult to rise any more. Charging from a USB port becomes more difficult because of the limited current rating of the micro B connector. Since the maximum current is around 2.0 A, most of which will be used by the electronic device itself and the applications running thereon, the current left for the charging may be very limited. In some cases, if an electronic device is active and has big applications, it cannot be guaranteed to be charged all the times even when the power supply is from an AC power source.

There is a need for a more reliable and effective charging solution with USB port.

### SUMMARY

In view of the above problem in the conventional technologies, a method and apparatus for charging an electronic device with USB port are provided.

According to one aspect of the invention, a method for charging a first electronic device by a second electronic device with USB connection is provided. The method comprises, at the side of the first electronic device, the steps of: receiving a power supply at a first voltage level from the second electronic device; detecting whether there is data communication on the USB connection, if there is no data communication on the USB connection, transmitting a message to the second electronic device to request for being charged at a second voltage level which is greater than the first voltage level; and receiving a power supply at the second voltage level from the second electronic device.

According to one aspect of the invention, a method for charging a first electronic device by a second electronic device with USB connection is provided. The method comprises, at the level of the second electronic device, the steps of: outputting a first voltage level to charge the first device; and upon receipt of a message from the first electronic device to request for being charged at a second voltage level which is greater than the first voltage level, switching to output a second voltage level to charge the first device.

According to one aspect of the invention, an apparatus provided with a USB port and receiving a power supply at a first voltage level from an electronic device with USB connection is provided. The apparatus comprises a processor configured to: detect whether there is data communication on the USB connection; transmit a message to the electronic device to request for being charged at a second voltage level which is greater than the first voltage level if there is no data communication on the USB connection; and receive a power supply at the second voltage level from the electronic device.

According to one aspect of the invention, an apparatus provided with a USB port and outputting a first voltage level to charge an electronic device with USB connection is provided. The apparatus comprises a processor configured to: switch to output a second voltage level which is greater than the first voltage level to charge the first device upon receipt of a message from the electronic device to request for being charged at the second voltage level.

It is to be understood that more aspects and advantages of the invention will be found in the following detailed description of the present invention.

### BRIEF DESCRIPTION OF THE DRAWINGS

The accompanying drawings are included to provide further understanding of the embodiments of the invention together with the description which serves to explain the principle of the embodiments. The invention is not limited to the embodiments.

In the drawings:

FIG. 1 is a block diagram showing a tablet computer charged by a power supply unit with USB connection according to an embodiment of the invention;

FIG. 2 is a flow chart of a method for charging a tablet computer with USB port at the side of the tablet computer according to an embodiment of the invention; and

FIG. 3 is a flow chart of a method for charging a tablet computer with USB port at the side of a power supply unit according to an embodiment of the invention.

### DETAILED DESCRIPTION

An embodiment of the present invention will now be described in detail in conjunction with the drawings. In the following description, some detailed descriptions of known functions and configurations may be omitted for conciseness.

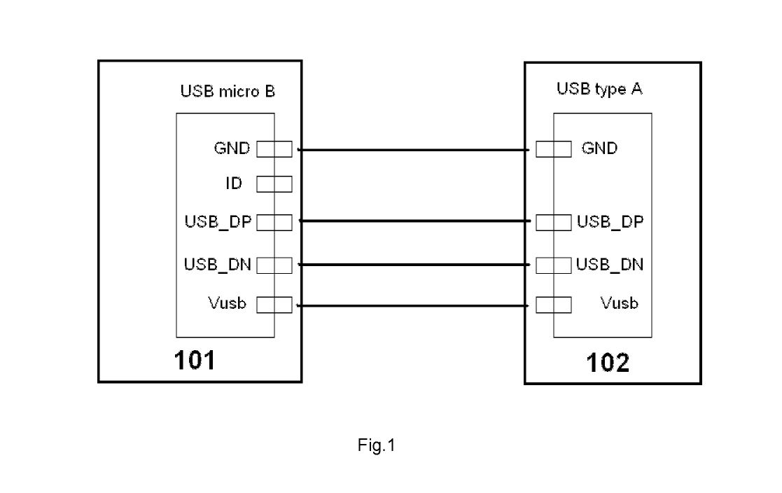

FIG. 1 is a block diagram showing a tablet computer charged by a power supply unit (PSU) with USB connection according to an embodiment of the invention.

As shown in FIG. 1, a tablet computer 101 is charged by a PSU 102 which is connected to the tablet computer 101 with USB connection.

As described above, the PSU 102 can be an electronic device, for example, a personal computer, which can provide power to charge the tablet computer 101 from its battery or from an AC power source. The PSU 102 can also be an adapter connected to an AC power supply, which can charge the tablet computer 101 from the AC power source. In this example, the PSU 102 operates as a charger to charge the battery of the tablet computer 101 when they are connected with USB port. Generally there are two kinds of charger, one is dedicated charger which does not include USB data connection and the other includes 5.0V power supply and a data connection.

As shown in FIG. 1, the PSU 102 is provided with a USB type A connector which is connected with the USB micro B connector provided on the tablet computer 101.

It is known that a USB connector can be in the form of a receptacle or a plug. The connector mounted on the host or device is called the receptacle, and the connector attached to the cable is called the plug. The USB specification specifies several types of connectors to support the defined functions of the USB port. The standard connectors specified in the USB specification comprise a type A connector which is used on a host electronic device to supply power and a type B connectors which is provided on a target electronic device to receive power. The classification of the type of connector is intended to prevent users from accidentally connecting two USB power supplies to each other, which could lead to dangerously high currents and circuit failures. The USB specification also defines Mini and Micro connectors, which have been used for smaller devices such as digital cameras, smartphones, and tablet computers. Full information on the USB connectors is available from the USB specification and no further details will be provided. For illustrative purpose, this example is described in a context that the PSU 102 uses the type A receptacle and the tablet computer 101 uses the micro B receptacle which is normally used for the charging function. Micro B can output power supply which relies on the ID pin of the USB connector. A device will receive power when the ID pin is floating and output power supply when ID pin is low. As shown in FIG. 1, the ID pin of the USB connector of the PSU 102 is floating. It can be appreciated by a person skilled in the art that other types of USB connectors can also be used for the charging, in which case the embodiment of the invention can also apply.

In the structure shown in FIG. 1, the USB_DP and USB_DN pins are used by the tablet computer 101 and the PSU102 for the communication and power supply therebetween. The USB_DP pin is for the possive signal of USB bus and the USB_DN pin is for the negative signal of USB bus. The Vusb pin shown in FIG. 1 is the power supply pin. The ID pin Permits distinction of a host connection from device connection: host: connected to the signal ground; device: not connected. And the GRND pin is for signal ground.

As default mode, the PSU 102 will output a voltage of 5V DC, and operate as DCP (Dedicated Charging Port). It is known that two types of charging ports were defined in the USB Battery Charging Specification: charging downstream ports (CDP), supporting data transfers as well, and dedicated charging ports (DCP), without data support.

The tablet computer 101 will detect whether the PSU 102 is a DCP which means that there is no data communication on the USB port. According to the USB specification, a portable device can recognize the type of USB port from the way the D+ and D− pins are connected. The specification specifies that, on a DCP, the D+ (Data+) and D− (Data−) lines will be shorted. That is, for the PSU 102 operating as a DCP, USB_DP and USB_DN will be shorted. When the tablet computer 101 is connected to the PSU 102 with USB port, the tablet computer 101 can determine the PSU 102 is a DCP by detecting that the USB_DP and USB_DN is shorted.

If the tablet computer 101 determines that there is no data communication on the USB port by detecting that the PSU 102 is a DCP, it will transmit a predefined pulse to the PSU 102 to request the PSU 102 to change to 12V DC output. It can be appreciated that the 12V DC output is described in this example for illustrative purpose only. The voltage level is increased to improve the charging in view of the limited currency. Other level of the increased voltage can also be used according to the application context and the capacity of the USB port.

The predefined signal can be transmitted periodically once the tablet computer 101 detects that the PSU 102 is a DCP. In one example, the predefined pulse can be a heart beat pulse. The predefined pulse can be transmitted through the USB_DP pin of the USB port of the tablet computer 101, and the PSU 102 can detect the predefined pulse through the USB_DN pin of the USB port. It should be noted that when a heart beat pulse is transmitted periodically through the USB_DP pin of the USB port, it will be impossible to further detect by the tablet computer 101 whether the PSU 102 is a DCP. In such case, the tablet computer 101 just keep on transmitting the heart beat pulse once it detects that the PSU 102 is a DCP.

When the PSU 102 receives a predefined pulse through the USB_DN pin, it will switch to output a voltage of 12V DC.

In this example, since the tablet computer 101 will periodically transmit a predefined pulse to the PSU 102 after it determines that the PSU 102 is a DCP, a predetermined time period can be set for the PSU 102 to determine whether to continue to output a voltage of 12V DC. If no predefined pulse is received from the tablet computer 101 within the predetermined time period (for example, in a case that the USB connection is lost), the PSU 102 will switch back output a voltage of 5V DC. The predetermined time period is preferably smaller than the period for the tablet computer 101 to periodically transmit the predefined pulse so that the PSU 102 can effectively determine whether it needs to switch back to output a voltage of 5V DC in order to avoid any potential damage to a newly connected electronic device which cannot not bear a voltage higher than 5V DC. In one example, the period for the tablet computer 101 to periodically transmit the predefined pulse is 1 s and the predetermined time period set for the PSU 102 is 0.5 s.

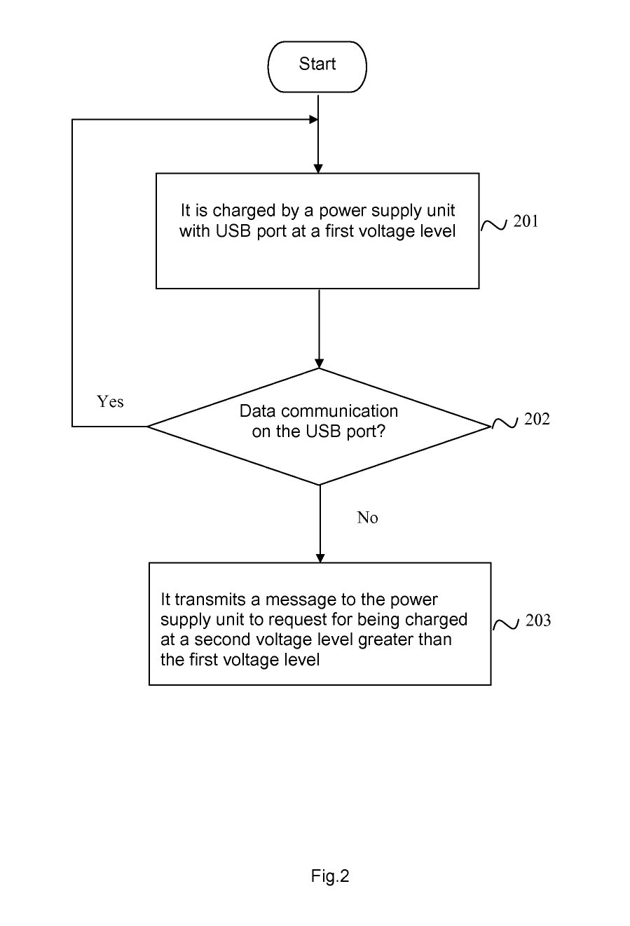

FIG. 2 is a flow chart of a method for charging a tablet computer with USB port at the side of the tablet computer according to an embodiment of the invention.

As shown in FIG. 2, at step S201, the tablet computer 101 is charged by the PSU 102 at a first voltage level of 5V DC.

At step 202, it detects whether there is data communication on the USB port. As described above, this can be done by detecting whether the USB_DP and USB_DN pins of the USB port are shorted. As described above, this can be done by detecting that the USB_DP and USB_DN of a USB port is shorted.

If the result of step S202 is no, the tablet computer 101 will transmit a message to the PSU 102 to request for being charged at a second voltage level of 12V DC. If the result of step S202 is yes, the tablet computer 101 will take no action and continue to be charged by the PSU 102 at a first voltage level of 5V DC.

The tablet computer 101 will keep on transmitting the message periodically to the PSU 102 if it detects there is no data communication on the USB port at step 202.

It can be appreciated that some certain conditions can be set to end the above process, for example, when detecting the tablet computer 101 is disconnected from the PSU 102. No further details will be given in this respect.

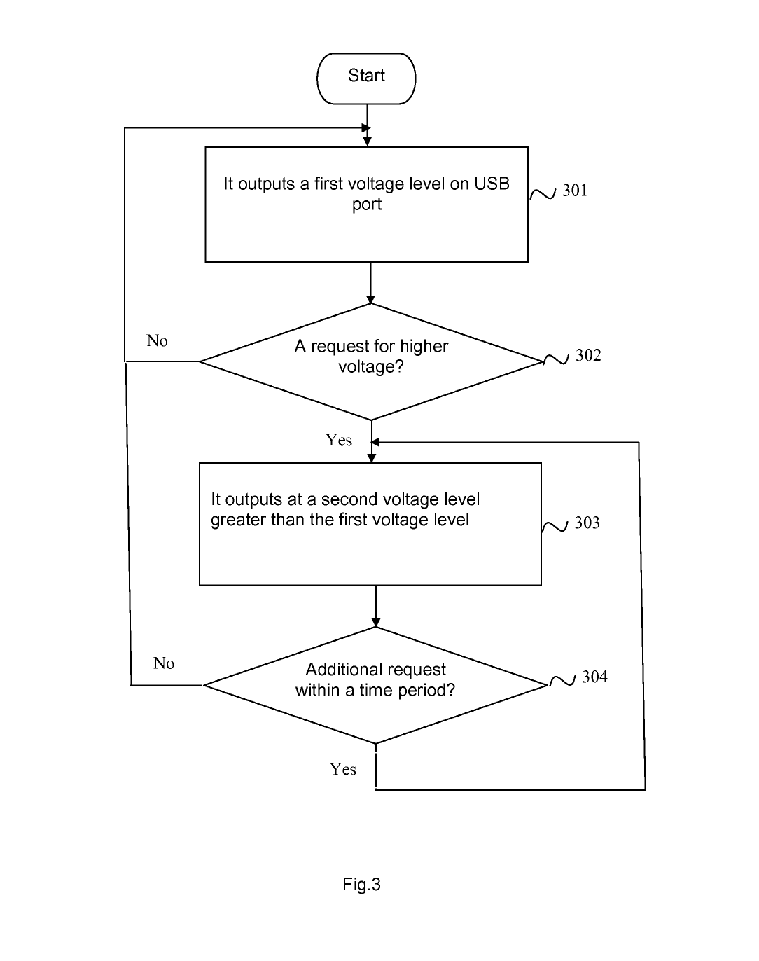

FIG. 3 is a flow chart of a method for charging a tablet computer with USB port at the side of a power supply unit according to an embodiment of the invention.

At step S301, the PSU102 outputs a first voltage level of 5V DC to charge the tablet computer 101.

At step S302, it detects whether a message from the tablet computer 101 to request for being charged at a second voltage level of 5V DC is received.

If the result of step S302 is no, the PSU102 will keep on outputting a first voltage level of 5V DC to charge the tablet computer 101.

If the result of step S302 is yes, at step S303, it switches to output a second voltage level of 12V DC to charge the tablet computer 101.

At the next step S304, it detects whether additional message from the first electronic device to request for being charged at a second voltage level is received within a determined time period.

If the result of step S304 is yes, the PSU102 will keep on outputting a second voltage level of 12V DC to charge the tablet computer 101.

If the result of step S304 is no, at step S303, it switches back to output a first voltage level of 5V DC.

It can be appreciated that some certain conditions can be set to end the above process, for example, when detecting the tablet computer 101 is disconnected from the PSU 102. In this case, the PSU 102 will output a first voltage level of 5V DC as defined in the USB specification when reconnected with an electronic device. No further details will be given in this respect.

The invention is described with reference to an embodiment that a tablet computer being charged by a power supply unit with USB connection. It should be noted that the invention can apply to all applications that an electronic device is charged with USB connection, either by another electronic device or by a dedicated power supply.

It is to be understood that the present invention may be implemented in various forms of hardware, software, firmware, special purpose processors, or a combination thereof. Specifically, the invention can be implemented in an electronic device comprising a processor configured to perform the steps of the method described in the embodiment of the invention. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1-15. (canceled)

16. A method for charging a first electronic device by a second electronic device with a connection which can also provide data communication thereon, comprising, at the side of the first electronic device, the steps of:
receiving a power supply at a first voltage level from the second electronic device;
detecting whether there is data communication on the connection,
if there is no data communication on the connection, transmitting a message to the second electronic device to request for being charged at a second voltage level which is greater than the first voltage level; and
receiving a power supply at the second voltage level from the second electronic device.

17. The method according to claim 16, wherein the connection is in conformity with the universal serial bus (USB) protocol.

18. The method according to claim 17, further comprising detecting there is no data communication on the USB connection when the USB_DP and USB_DN pins of a USB port of the second electronic device are shorted.

19. The method according to claim 17, wherein the first voltage level is 5V DC and the second voltage level is 12V DC.

20. The method according to claim 17, further comprising transmitting the message via the USB_DP pin of a USB port of the first electronic device.

21. The method according to claim 17, wherein the message is transmitted periodically.

22. The method according to claim 21, wherein the message is in a form of a heart beat pulse.

23. A method for charging a first electronic device by a second electronic device with a connection which can also provide data communication thereon, comprising, at the level of the second electronic device, the steps of:
outputting a first voltage level to charge the first device; and
upon receipt of a message from the first electronic device to request for being charged at a second voltage level which is greater than the first voltage level, switching to output a second voltage level to charge the first device.

24. The method according to claim 23, wherein the connection is in conformity with the universal serial bus (USB) protocol.

25. The method according to claim 24, further comprising receiving the message via the USB_DN pin of a USB port of the second electronic device.

26. The method according to claim 24, further comprising
switching back to charge the first device at the first voltage level if no additional message from the first electronic device to request for being charged at a second voltage level is received within a determined time period.

27. An apparatus provided with a USB port and receiving a power supply at a first voltage level from an electronic device with USB connection, comprising a processor configured to:
detect whether there is data communication on the USB connection;
transmit a message to the electronic device to request for being charged at a second voltage level which is greater than the first voltage level, if there is no data communication on the USB connection; and
receive a power supply at the second voltage level from the electronic device.

28. An apparatus provided with a USB port and outputting a first voltage level to charge an electronic device with USB connection, comprising a processor configured to:
switch to output a second voltage level which is greater than the first voltage level to charge the first device upon receipt of a message from the electronic device to request for being charged at the second voltage level.

29. The apparatus according to claim 28, wherein the apparatus is an electronic device which provides power supply to another electronic device from its battery or from an AC power source.

30. The apparatus according to claim 28, wherein the apparatus is an adapter connected to an AC power source.
